(19) United States
(12) Patent Application Publication
(10) Pub. No.: US 2006/0171976 A1
(43) Pub. Date: Aug. 3, 2006

(54) Mold resistant gypsum wallboard

(75) Inventors: Richard P. Weir, Indian Trail, NC (US); Kendall L. Clark, Charlotte, NC (US); William C. Martin, Charlotte, NC (US); Daniel A. Winkowski, Sun City Grand Surprise, AZ (US)

Correspondence Address: ICE MILLER LLP, ONE AMERICAN SQUARE, SUITE 3100, INDIANAPOLIS, IN, 46282-0200, US

(73) Assignee: National Gypsum

(21) Appl. No.: 11/050,257

(22) Filed: Feb. 1, 2005

(51) Int. Cl. A01N 25/00; B32B 29/02

(52) U.S. Cl. 424/405; 428/292.7

(57) ABSTRACT

Mold resistant wallboards and methods of making mold resistant wallboards are provided. Illustrative wallboards have a first antimicrobial composition in the core and a second antimicrobial composition in the facing.

### BACKGROUND

1. Field of the Invention

The present invention relates generally to the production of gypsum board materials and is more particularly directed to gypsum board that is resistant to mold growth.

2. Description of Related Technology

One of the most common ways of constructing walls and barriers includes the use of inorganic wallboard panels or sheets, such as gypsum wallboard, often referred to simply as “wallboard” or “drywall.” Wallboard can be formulated for interior, exterior, and wet applications. The use of wallboard, as opposed to conventional wet plaster methods, is often desirable because the installation of wallboard is ordinarily less costly than installation of conventional plaster walls.

The presence of mold in buildings is of concern to many people. Mold growth occurs when there is a constant source of moisture in the building, such a from a leak or from outside sources (e.g. rain through roof), or from inside sources (e.g. plumbing). Mold is also problematic after flooding and in humid areas. Recently, interior and other goods such as clothes, bedding, furniture, carpets, and so on have been treated to prevent mold and other microbes from proliferating to provide a more comfortable life environment.

Since mold can grow on building materials such as gypsum board, wood, and wallpaper, anti-mold treatment is not limited to goods that people may touch directly, but may be extended to the building materials themselves. For example, mold resistant insulation may be used. For mold to grow, four conditions must be present simultaneously: sufficient moisture, the correct temperature range, mold spores, and an available food source. Because the paper facing on wallboard can support mold growth, wallboard can provide the food source. Accordingly, it is known to face the wallboard with fiber glass, or treat paper facing with an anti-mold composition, to provide a mold resistant wallboard. Wallboard that prevents or reduces mold growth can improve conditions inside the building and can be used to keep mold from spreading from one room to another. Such wallboard would also be effective in areas prone to flooding, to retard mold growth and reduce the need for replacement of the wallboard. Such wallboard would contribute to a cleaner building environment.

Generally, wallboard is conventionally produced by enclosing a core of an aqueous slurry of calcined gypsum and other materials between two large sheets of board cover paper. Various types of cover paper are known in the art, as are other types of facing materials. After the gypsum slurry has set (i.e., reacted with the water from the aqueous slurry) and dried, the sheet is cut into standard sizes. Methods for the production of gypsum wallboard are described, for example, in the Kirk-Othmer Encyclopedia of Chemical Technology, Second Edition, 1970, Vol. 21, pages 621-24, the disclosure of which is hereby incorporated herein by reference.

Gypsum wallboard is typically manufactured commercially by processes that are capable of operation under continuous high speed conditions. The aqueous slurry of calcined gypsum and other ingredients is continuously deposited to form a core between two continuously-supplied moving sheets of cover paper. The calcined gypsum forming the core between the two cover sheets is then allowed to set. The continuously-produced board is cut into panels of a desired length (for example, eight feet) and then passed through a drying kiln in which excess water is removed and the gypsum is brought to a final dry state. After the core has set and is dried, the sandwich becomes a strong, rigid, fire-resistant building material.

A major ingredient of the gypsum wallboard core is calcium sulfate hemihydrate, commonly referred to as “stucco” or “plaster of Paris.” Stucco is commonly manufactured by drying, grinding, and calcining natural gypsum rock. The drying step of stucco manufacture includes passing crude gypsum rock through a rotary kiln to remove any free moisture accumulated in the rock from rain or snow, for example. The dried rock is then passed through a roller mill (a type of pulverizer), wherein the rock is ground to a desired fineness. The dried, ground gypsum is often referred to as “land plaster.”

The calcination step is performed by heating the ground gypsum rock, and is described by the following chemical equation:
CaSO₄.2H₂O+heat →CaSO₄.½H₂O+1½H₂O

This equation shows that calcium sulfate dihydrate plus heat yields calcium sulfate hemihydrate (stucco) plus water vapor. This process is conducted in a “calciner,” of which there are various types known in the art.

Uncalcined calcium sulfate (the land plaster) is the “stable” form of gypsum. However, calcined gypsum, or stucco, is chemically reactive with water, and will “set” rather quickly when mixed with water. This setting reaction is actually a reversal of the above-described chemical reaction performed during the calcination step. The reaction proceeds according to the following equation:
CaSO₄.½H₂O+1½H₂O→CaSO₄.2H₂O+heat.
In this reaction, the calcium sulfate hemihydrate is rehydrated to its dihydrate state over a fairly short period of time. The actual time required for this setting reaction is generally dependent upon the type of calciner employed and the type of gypsum rock that is used, and can be controlled within certain limits by the use of additives such as accelerators and retarders.

It is known to treat the paper facing with an antimold composition, to provide a mold resistant wallboard. For example, XP Wallboard, XP Hi-Abuse Wallboard, and XP Hi-Impact Wallboard (National Gypsum, Co., Charlotte, N.C.) all have a paper facing that is treated with Zinc OMADINE® (Arch Chemicals, Co.). In these products, the Zinc OMADINE® treated paper is used on both the front and back faces of the wallboard and provides a significant level of mold resistance.

However, certain types of wallboard are more prone to mold growth and may benefit from further treatment. For example, wallboard cores that lack wax or silicone, such as those used for interior dry applications are more prone to water penetration than some other wallboards. Such wallboards would benefit from having an antimold composition in the core itself, as well as an antimold treated facing. Furthermore, starch is used in some core compositions. During manufacture of the wallboard, as water is driven out of the core, the starch migrates to the facing/core interface. While the accumulation of starch on the back surface of the paper facing helps bond the paper to the core, the starch also provides a good medium for mold growth. Wallboards having an antimold composition at this interface would be desirable.

### SUMMARY OF THE INVENTION

Accordingly, the present invention is directed to a mold resistant wallboard having an antimold composition in the facing material and an antimold composition in the core. Illustratively, the antimold composition in the facing material is an insoluble compound, to minimize leaching of the antimold composition from the facing material. In one embodiment, a soluble antimold composition is used in the core material.

Methods for making the mold resistant wallboard are also provided. Illustratively, a mold resistant wallboard produced by enclosing an aqueous core between two sheets of facing, allowing the core to set, and drying the core, wherein the aqueous core comprises a first antimicrobial composition and the sheets of facing each comprise a second antimicrobial composition.

Other objects and advantages of the invention will be apparent to those skilled in the art from the following detailed description, taken in conjunction with the appended claims.

### DETAILED DESCRIPTION

According to the invention, there are provided wallboard compositions including a facing treated with an antimicrobial composition and a core treated with an antimicrobial composition, to provide a wallboard having desirable antimicrobial properties.

An illustrative method process for manufacturing the core composition and wallboard of the invention initially includes the premixing of dry ingredients in a mixing apparatus. The dry ingredients can include calcium sulfate hemihydrate (stucco), an accelerator, and an antidesiccant (e.g., starch), as described below in greater detail.

The dry ingredients are mixed together with a “wet” (aqueous) portion of the core composition illustratively in a pin mixer apparatus. The wet portion can include a mixture of water, paper pulp, and, optionally, fluidity-increasing agents. A set retarder, foam, starch, and other conventional additives may be included, if desired.

In addition to the above “wet” ingredients, an antimicrobial composition may be included. Those that are water-soluble, such as Sodium OMADINE® (Arch Chemicals Co.), are particularly well suited. Sodium OMADINE® fungicides are highly active, very effective water soluble industrial biocides. Sodium OMADINE® fungicide is a derivative of pyrithione and is also known as sodium pyrithione:

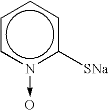

Sodium OMADINE® fungicide is known to exhibit pronounced growth-inhibiting activity against both yeasts and molds. It is believed to be both nonirritating and nonsensitizing to humans. It is known to use sodium OMADINE® in latex paints as an effective wet-state preservative against bacteria and fungus at about 1,000 parts per million. In gypsum wallboard, it has been found that concentrations of 4.5 g to 45 kg (about 0.01 to 100 pounds) of sodium OMADINE®, more illustratively 45 g to 2.3 kg (about 0.1 to 5 pounds) of sodium OMADINE® per thousand feet of wallboard are particularly effective. Illustratively, sodium OMADINE® is added to the mixer at a dilution to provide 230 g (about 0.5 pounds) sodium OMADINE® per thousand feet of wallboard.

The facing material of the wallboard of the present invention can be any facing material known in the art, including paper and fiberglass. Illustratively, a heavy 100% recycled paper is used on the face and back sides. Optionally, the face paper may be folded around the long edges to reinforce and protect the core. In an illustrative example, the ends are square-cut and finished smooth, and the long edges of the panels have a double-beveled edge for ease of installation. The paper is treated with an insoluble antimicrobial composition, such as zinc OMADINE®.

Zinc OMADINE® (Arch Chemicals, Inc, Cheshire, Conn.) products are highly active, broad spectrum antimicrobial agents. Zinc OMADINE® fungicide-algaecide is zinc pyrithione, the zinc complex of pyrithione:

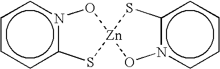

Zinc OMADINE® fungicide-algaecide is the active ingredient in various antidandruff shampoo products. In industrial applications, zinc OMADINE® products offer antimicrobial protection to substrates both in the wet (in-can) as well as in the dry film state. In dry film applications, zinc OMADINE® products also afford exceptional protection against algae growth in addition to mildew. Zinc OMADINE® may be provided at any suitable concentration, illustratively 1.0 g to 20 kg (about 0.022 to 44 pounds), and more illustratively 25 g to 2 kg (about 0.055 to 4.4 pounds) per thousand square feet of paper. Illustratively 250 g (about 0.55 pounds) per thousand square feet of paper is used.

It is understood, however, that other suitable antimicrobial products may be used instead of or in addition to sodium and zinc OMADINE®. Such antimicrobial products include, but are not limited to, 2-[(thiocyanotomethyl)thio]- Benzothiazole (BUSAN), 2-(4′-thiazolyl) benzimidazole, 10,10′-oxybisphenoxyarsine, and PREVENTOL anti-molding agents such as N-(fluorodichloro-methylthio)phthalimide, N-dimethyl-N′-phenyl-(N′-fluorodichloromethylthio) sulfamide. Illustratively, a water-soluble antimicrobial product is used in the core and a water-insoluble antimicrobial product is used in the facing material.

Illustratively, the produced core composition slurry, as discussed above, is deposited between two layers of the facing material to form a sandwich. The core composition is allowed to cure or set, whereby calcium sulfate hemihydrate is converted to calcium sulfate dihydrate. The product is then preferably dried to remove any excess water not consumed in the reaction forming the calcium sulfate dihydrate. (Excess water has preferably been included to decrease the viscosity of the slurry during production.)

The setting reaction produces gypsum crystals, which are interwoven to contribute strength to the wallboard core. The crystal-to-crystal interaction is important to the final strength of the gypsum wallboard product. The gypsum crystals also preferably interlock with facing fibers protruding from the surface or cover papers, thus bonding the facing to the core. If starch is added to the core mix, the starch further acts as a bonding agent between the facing material and the gypsum core. During the drying process, excess water is driven out of the core. The starch migrates with the water and the starch accumulates at the facing/core interface, and, in addition to the gypsum crystals, bonds the facing to the core. This accumulation of starch, in addition to acting as a bonding agent, also provides a very good medium for mold growth. By incorporating a soluble antimicrobial agent into the core, the soluble antimicrobial agent also migrates to the facing/core interface, to provide enhanced antimicrobial protection at this location.

Illustrative ingredients of the wallboard core composition of the invention will now be described in more detail. The first ingredient of the wallboard core composition of the invention is calcium sulfate hemihydrate, or stucco (CaSO₄.½H₂O). Calcium sulfate hemihydrate can be produced by the methods described above. Calcium sulfate is described in the Kirk-Othmer Encyclopedia of Chemical Technology, Fourth Edition, Vol. 4, pages 812-26, the disclosure of which is hereby incorporated herein by reference.

As is known by those of skill in the art, there are two types of calcium sulfate hemihydrate, the a-hemihydrate form and the β-hemihydrate form. These two forms are typically produced by different types of calcination processes and differ structurally to some extent. Either type of calcium sulfate hemihydrate is suitable for use with the invention.

Other dry ingredients are preferably included in the core composition, including an accelerator which can be used to control, within certain limits, the crystal growth rate and set time of the stucco. Examples of suitable accelerators include ball mill accelerators (“BMA”) and potassium sulfate, although many others are known to those of skill in the art. In some cases, the invention may require increased amounts of accelerator due to the retarding effect of some of the strength-enhancing additives.

In some products, lightweight aggregates (e.g., expanded perlite or vermiculite) can be included.

An aqueous slurry or solution of paper pulp may also be included in the core composition. The pulp solution comprises water and paper fibers (“paper pulp”), and may also include a retarder, corn starch, and/or potash. The retarder is used in conjunction with the aforementioned accelerator in order to tailor the set time of the core composition. Retarding agents are typically used in with the invention at very low rates (if at all), for example at about 0.0007 weight percent, based on the weight of the core composition.

The paper pulp solution can also include one or more of a number of additives that increase the fluidity of the slurry and/or reduce the water requirements of slurry. Materials used as fluidity-enhancing and/or water-reducing agents include “lignosulfonates” which are available commercially either in liquid or powder form. Agents supplied in liquid form can be either incorporated in the pulp solution or added directly to the mixing operation.

The pulp solution can be prepared by blending or mixing the above ingredients with water in a blending apparatus. Alternatively, a concentrated pulp solution using only a small volume of water can be produced. In this case, the remainder of the core mix water requirement is made up with a separate water source. An excess of water with respect to the above-described rehydration reaction is preferably included in order to provide satisfactory flowability of the core composition. Typically, about 75 weight parts water are used per 100 weight parts stucco. Preferably, high shear mixing “pulps” the material, forming a homogenous solution or slurry. The pulp solution can be transferred to a holding vessel, from which it can be continuously added to the core composition mix. The paper fibers in the pulp solution serve to enhance the flexibility of the gypsum wallboard. Gypsum wallboard made without fibers is typically very brittle and more susceptible to breakage during handling. The paper fibers also aid in evenness of drying during manufacture, as well as enhance the ability of the final wallboard product to accept and hold nails during installation.

As indicated above, the wet portion of the core composition also preferably includes a component that incorporates both a foam and a strength-enhancing agent.

Foam introduces air voids into the core through the use of a foam that contains very little solid material, but is resilient enough to resist substantial breakdown in the mixing operation. In this manner, the density of the core can be controlled. Known foaming agents may be supplied in either liquid or flake (powdered) form, and may be produced from soaps known in the art.

The wallboard of the present invention is designed to provide extra protection against mold and mildew. When tested by an independent laboratory per ASTM D3273 (“Standard Test Method for Resistance to Growth of Mold on the Surface of Interior Coatings in an Environmental Chamber”), illustrative examples achieved a panel score of 10, the highest score possible, indicating no mold growth under the laboratory test conditions.

The foregoing detailed description is given for clearness of understanding only, and no unnecessary limitations should be understood therefrom, as modifications within the scope of the invention will be apparent to those skilled in the art. For example, the order in which the ingredients of the core composition are combined can be altered without negatively affecting the properties of the produced wallboard.

1. A wallboard comprising
a core comprising a first antimicrobial composition, the core having a front face, and
a sheet of facing material affixed to the front face, the sheet of facing material comprising a second antimicrobial composition.

2. The wallboard of claim 1 wherein the first antimicrobial composition is different from the second antimicrobial composition.

3. The wallboard of claim 2 wherein
the first antimicrobial composition is water soluble, and
the second antimicrobial composition is water insoluble.

4. The wallboard of claim 3 wherein
the first antimicrobial composition is sodium pyrithione, and
the second antimicrobial composition is zinc pyrithione.

5. The wallboard of claim 4 wherein
the sodium pyrithione is provided at a concentration of 45 g to 2.3 kg (about 0.1 to 5 pounds) per thousand feet of wallboard.

6. The wallboard of claim 5 wherein
the sodium pyrithione is provided at a concentration of about 230 g (about 0.5 pounds) per thousand feet of wallboard.

7. The wallboard of claim 4 wherein
the zinc pyrithione is provided at a concentration of 25 g to 2 kg (about 0.055 to 4.4 pounds) per thousand feet of wallboard.

8. The wallboard of claim 7 wherein
the zinc pyrithione is provided at a concentration of about 250 g (about 0.55 pounds) per thousand feet of wallboard.

9. The wallboard of claim 1 wherein
the core further comprises a back face opposite the front face, and
the wallboard further comprises a second sheet of facing material affixed to the back face, the second sheet of facing material comprising the second antimicrobial composition.

10. A mold resistant wallboard produced by
enclosing an aqueous core between two sheets of facing,
allowing the core to set, and
drying the core,
wherein the aqueous core comprises a first antimicrobial composition and the sheets of facing each comprise a second antimicrobial composition.

11. The mold resistant wallboard of claim 10 wherein upon drying, the sheets of facing become affixed to the core at a core/facing interface.

12. The mold resistant wallboard of claim 11 wherein the first antimicrobial composition is water soluble.

13. The mold resistant wallboard of claim 12 wherein upon drying at least some of the first antimicrobial composition migrates to the core/facing interface.

14. The mold resistant wallboard of claim 11 wherein the aqueous core further comprises starch, and at least some of the starch migrates to the core/facing interface during drying.

15. The mold resistant wallboard of claim 10 wherein
the aqueous core further comprises calcined gypsum.

16. The mold resistant wallboard of claim 15 wherein
the aqueous core further comprises paper pulp, a set retarder, foam, and starch.

17. The mold resistant wallboard of claim 10 wherein
the facing is paper.
